(19) United States
(12) Patent Application Publication
(10) Pub. No.: US 2024/0264786 A1
(43) Pub. Date: Aug. 8, 2024

(54) TRANSLATION METHOD, TRANSLATOR, AND ASSOCIATED DISPLAY

(71) Applicant: REALTEK SEMICONDUCTOR CORPORATION, HSINCHU (TW)

(72) Inventors: CIAN-ROU WU, HSINCHU COUNTY (TW); CHENG YUEH CHEN, HSINCHU COUNTY (TW); CHUN-CHIEH CHAN, HSINCHU COUNTY (TW); WEN-HSIA KUNG, HSINCHU COUNTY (TW)

(21) Appl. No.: 18/311,144

(22) Filed: May 2, 2023

(30) Foreign Application Priority Data
Feb. 3, 2023 (TW) 112103931

(51) Int. Cl. G06F 3/14; G06F 3/0354

(52) U.S. Cl. CPC G06F 3/14; G06F 3/03543

(57) ABSTRACT

A translation method configured to translate a device to hosts includes: according to a first control signal generated by the device, determining a first host and a second host from the hosts; generating a pseudo signal; transmitting a first data signal generated by the device to the first host, and transmitting the pseudo signal to the second host, so as to make the first host and the second host remain in a handshake completion state with the device at the same time.

### CROSS-REFERENCE TO RELATED APPLICATIONS

This application claims the benefit of priority to patent application Ser. No. 11/210,3931, filed in Taiwan on Feb. 3, 2023, which is incorporated by reference in its entirety.

### TECHNICAL FIELD

The present application relates to a translation method, a translator and an associated display; in particular, to a translation method, a translator and an associated display for reducing delays between switching.

### BACKGROUND

When the translator is connected to multiple hosts, each operation for switching host requires re-performing a handshake between the host going to be used and the device, and the user will feel a delay of the switching as a result of the time required for the handshake.

### SUMMARY OF THE INVENTION

An aspect of the present disclosure provides a translation method configured to translate a device to hosts includes: according to a first control signal generated by the device, determining a first host and a second host from the hosts; generating a pseudo signal; transmitting a first data signal generated by the device to the first host, and transmitting the pseudo signal to the second host, so as to make the first host and the second host remain in a handshake completion state with the device at the same time.

Another aspect of the present disclosure provides a translator configured to translate a device to hosts. The translator includes a translation unit and a signal generating unit. The translation unit is configured to receive a first control signal generated by the device, and determine a first host and a second host of the hosts according to the first control signal. The first host is active, and the second host is idle. The signal generating unit is configured to generate a pseudo signal. The translation unit is further configured to transmit a first data signal generated by the device to the first host and transmit the pseudo signal to the second host, so as to make the first host and the second host remain in a handshake completion state with the device at the same time.

Yet another aspect of the present disclosure provides a display configured to translate a device to hosts. The display includes a signal generating unit, a translation unit, and a panel. The signal generating unit is configured to generate a pseudo signal. The translation unit is configured to: receive a first control signal generated by the device, and determine a first host and a second host of hosts according to the first control signal; transmit a first data signal generated by the device to the first host, and transmit the pseudo signal to the second host, so as to make the first host and the second host remain in a handshake completion state with the device at the same time; and receive a first image signal generated by the first host according to the first data signal. The panel is configured to display the first image signal.

Compared with the conventional art, the translation method, the translator and the associated display of the present disclosure are able to use pseudo-signals to keep the idle hosts in a handshake completion state, thereby reducing the delay in switching hosts, so as to enhance the user experience.

### BRIEF DESCRIPTION OF THE DRAWINGS

Aspects of the present disclosure are best understood from the following detailed description when read with the accompanying drawings. It is noted that, in accordance with the common practice in the industry, various features are not drawn to scale. In fact, the dimensions of certain features may be arbitrarily increased or reduced for clarity of discussion.

FIG. 1 is a schematic diagram illustrating a translator according to some embodiments of the present disclosure.

FIG. 2 is a schematic diagram illustrating a transmission of a USB interface according to some embodiments of the present disclosure.

FIG. 3 is a schematic diagram illustrating a display according to some embodiments of the present disclosure.

FIG. 4 is a flow chart of a translation method according to other embodiments of the present disclosure.

### DETAILED DESCRIPTION

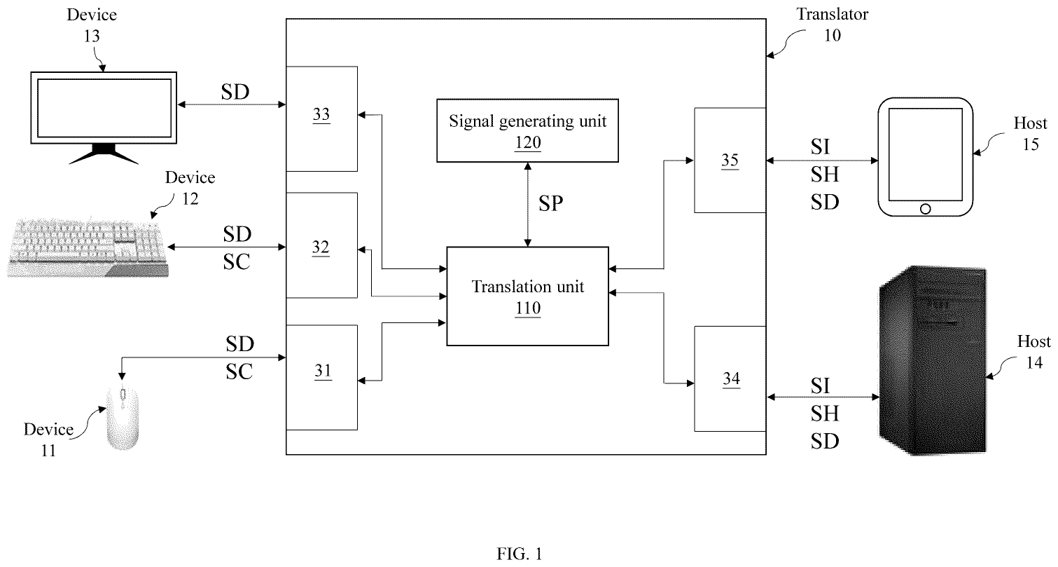

FIG. 1 is a schematic diagram illustrating a translator 10 that translates devices 11, 12, 13 to hosts 14, 15 according to some embodiments of the present disclosure. The translator 10 is configured to translate the devices 11, 12, 13 to the hosts 14, 15. In some embodiments, the devices 11, 12, 13 are a mouse, a keyboard and a display, respectively; when a user uses the mouse, the keyboard and the display to communicate with multiple hosts 14, 15, the translator 10 allow the user to operate multiple hosts 14, 15 through only one set of devices (i.e., the mouse, keyboard and display) without having to provide a set of devices for each of hosts 14, 15. For example, when the user decides to use the host 14, he/she can use the mouse (the device 11) or the keyboard (the device 12) to generate a control signal SC, which is transmitted to the translator 10, so as to notify the translator 10 to switch the host 14 to be active and switch the host 15 to be idle, and vice versa.

The translator 10 includes a translation unit 110, a signal generating unit 120, an interface 31, an interface 32, an interface 33, an interface 34 and an interface 35. As shown in FIG. 1, the translation unit 110 is connected to each of the interfaces 31 to 35 and the signal generating unit 120. The translator 10 uses the interface 31, the interface 32 and the interface 33 to connect to the devices 11, 12, 13, respectively, and uses the interface 34 and the interface 35 to connect to hosts 14, 15, respectively; wherein the interfaces 31 to 35 of the present disclosure are not limited to any particular specifications, such as USB, RS232, HDMI, DP, etc. Due to the configurations of the interfaces 31 to 35, the translator 10 is able to translate devices and the hosts of various communication protocols.

After the devices 11, 12, 13 are connected with the translator 10, each of hosts 14 and 15 transmits a driving signal SI to the devices 11, 12, and 13 through the translator 10, wherein the driving signal SI is configured to identify the devices 11, 12, and 13 for performing the handshake. After the handshake completion, the hosts 14 and 15 respectively transmits a handshake signal SH to the devices 11, 12, and 13, indicating that the hosts 14 and 15 are ready to receive a data signal SD transmitted from the devices 11, 12, and 13 or transmit a data signal SD to the devices 11, 12, and 13.

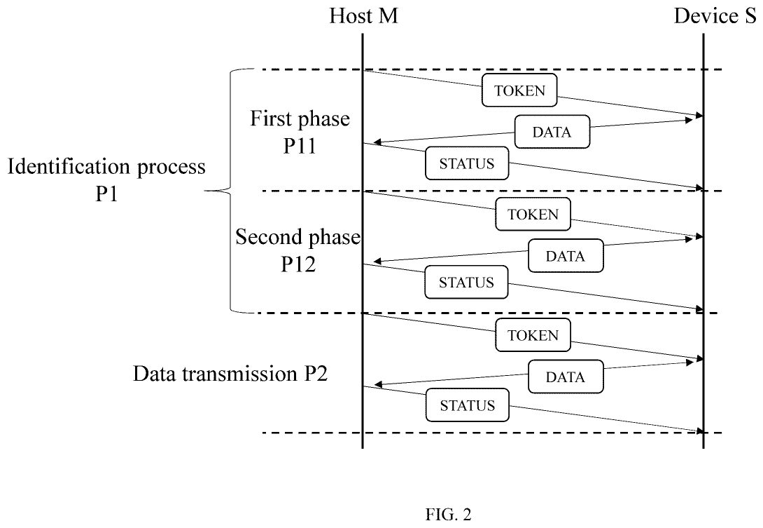

FIG. 2 is a schematic diagram illustrating the transmission of a USB interface according to some embodiments of the present disclosure. Take the USB interface for example, an identification process P1 is carried out before a host M and a device S perform a data transmission P2 through the translator 10. The identification process P1 includes a first phase P11 and a second phase P12. During the first phase P11, the host M determines that a descriptor set and an allocation location of the device S. During the second phase P12, the host M indicates that the enumeration and configuration are completed.

Each of the first phase P11, the second phase P12 and the data transmission P2 includes the transmissions of three packets: the host M transmits a token packet TOKEN (e.g., the above-mentioned driving signal SI) to the device S; determine whether a data packet DATA is transmitted from the host M to the device S or from the device S to the host M transmits according to the content of the token packet TOKEN; the host M transmits a handshake packet STATUS (e.g., the above-mentioned handshake signal SH) to the device to determine whether the current transmission is successful.

After the handshake packet STATUS of the second phase P12 indicates that the transmission of the second phase P12 is successful, the host M and the device S can perform data transmission P2 (e.g., transmission of the above-mentioned data signal SD). In some embodiments, when the host M is not switched to the idle state, the host M and the device S can perform multiple data transmissions P2, without the need to perform the identification process P1 again. To facilitate the discussion, in the present disclosure, the scenario where the host M can directly perform multiple times of data transmission P2 without the need to perform the identification process P1 again is referred to as remaining in the “handshake completion” state. In other words, if the host M is in the handshake completion state, the host M can communicate with the device S performs immediately without the need to perform the preliminary identification process P1.

In some embodiments, the host M can be the host 14 and/or the host 15, and the device S can be the devices 11, 12, and 13.

In some prior technologies, when the host is switched from the idle state to the active state, the host has to identifying the device (e.g., performing the identification process P1) again, then it can perform data transmission P2 with the device, and when the host is switched to the idle state, the host also needs to perform the identification process P1 again before performing the next data transmission P2. Furthermore, if the host does not perform any other operation during a predetermined period after completing the handshake, the host may be considered to be idle, and the host needs to perform the identification process P1 again before performing data transmission P2 with the device again. Therefore, after the user switches the host, the host needs to perform the identification process P1, so the user will feel a delay before the host continues to execute the data signal generated by the user through the device. Compared with these prior technologies, the translator 10 of the present disclosure can keep the host 14 and/or the host 15 in the handshake completion state when being idle, so that the host does not need to perform the identification process P1 again, and can directly perform data transmission P2. Specifically, the translator 10 utilizes the signal generating unit 120 to generate a pseudo signal SP and transmits the pseudo signal SP to the idle host to maintain the handshake completion state.

Take the embodiment of FIG. 1 for example, after the devices 11 to 13 and hosts 14 to 15 are connected to the translator 10, the hosts 14 and 15 completes the identification process P1. At this time, the user decides to use the host 14, and hence the translator 10 receives a corresponding control signal SC so that the host 14 remains in the active state and the host 15 is switched to the idle state. In this case, the translator 10 allows, through the translation unit 110, the host 14 and devices 11 to 13 to perform the data transmission P2. To maintain the host 15 in the handshake completion state, the translation unit 110 transmits the pseudo signal SP to the host 15, so as to make the host 15 and the translator 10 perform the data transmission P2.

Because the idled host 15 is not performing data transmission P2 with any of devices 11 to 13, the data packets DATA generated by devices 11 to 13 are not transmitted to the host 15. Because the host 15 does not receive the data signal SD that is actually transmitted by the user through devices 11 to 13, when the host 15 and the translator 10 perform the operation of data transmission P2, the host 15 remains in its original state. In other words, the pseudo signal SP is only intended to keep the host 15 remain in the handshake completion state, and in fact that the pseudo signal SP does not cause the host 15 to perform any operations.

When the user decides to use the host 15, the translator 10 receives a corresponding control signal SC to switch the host 15 to the active state and switch the host 14 to the idle state. Similarly, the host 15 and devices 11 to 13 perform the data transmission P2 through the translation unit 110, whereas the translation unit 110 transmits the pseudo signal SP to the host 14, such that the host 14 and the translator 10 perform the data transmission P2.

It should be noted that FIG. 2 is only a schematic diagram for the USB transmission; however, the present disclosure is not limited to the USB communication protocol. In various communication protocols, there is a preceding preparatory process (such as the identification process P1 shown in FIG. 2) before the transmission of data signal (such as the data transmission P2 shown in FIG. 2).

In some embodiments, the translation unit 110 of the translator 10 has a function to support different versions of communication protocols. When the function is on, the data signal SD among the devices 11, 12, and 13 and the hosts 14, and 15 can be compatible and transmitted properly. However, it takes extra computation resource for the translator 10 execute the function to support different versions of communication protocols, and hence, in some embodiments, the user can generate a control signal SC using one of the devices 11, 12, and 13 to turn on or turn off the translator 10's function of supporting different versions of communication protocols. For example, when the communication protocol versions of devices 11, 12, and 13 and hosts 14, and 15 are the same, the user can turn off the translator 10's function of supporting different versions of communication protocols, thereby reducing the work load of the translator 10.

In some embodiments, the translation unit 110 has the function to support HDMI 2.0 and HDMI 1.4. In some embodiments, the translation unit 110 has the function to support HDCP 2.2 and HDCP 1.4.

In order to make the user can quickly switch the hosts 14 and 15, in some embodiments, the user inputs a set of input combinations (also called shortcut keys, hot keys) on the keyboard (device 12) to generate the control signal SC. The translator 10 is configured to identify the control signal SC represented by the input combination, wherein when the translator 10 receives the control signal SC representing the input combination, it will not transmit the control signal SC to the hosts 14 and 15, but will switch the hosts 14 and 15 according to the control signal SC. For example, inputting“CTRL+1” may switch the host 14 to active and switch the host 15 to idle; and inputting“CTRL+2” may switch the host 15 to active and switch the host 14 to idle.

In other embodiments, the user can further control an on-screen display (OSD) of the display (device 13) through the control signal SC. For example, when the user inputs a corresponding input combination on the keyboard (device 12), which is identified by the translator 10 and then an eagle eye mode of the display will be turned on.

In some embodiments, the user can use the mouse (device 11) to move the mouse indicator of the mouse (device 11) out of a boundary of display range of the display (device 13), which is used as a control signal for switching the hosts 14 and 15. When the user is using the host 14, the user moves the mouse to generate a data signal SD associated with the movement of the mouse indicator, the translator 10 transmits the data signal SD to the host 14, and the host 14 correspondingly generates an image signal associated with the mouse movement (also referred to as the data signal SD), which is displayed on the display; when the translator 10 identifies that the mouse indicator has moved to the boundary of display range of the display, the translator 10 switches the host 14 to be idle and switches the host 15 to be active. After switching, the user may continue to move the mouse and continue to generate the data signal SD, and the host 15 will continue to receive the data signal SD to generate a corresponding image signal (also a data signal SD) for display on the display. Based on the above description, the data signal SD associated with the movement of the mouse indicator to the boundary of display range of the display is a data signal SD and also a control signal SC for the translator 10.

In some embodiments, the signal generating unit 120 can be disposed within the translation unit 110. For example, the translation unit 110 and the signal generating unit 120 are disposed on a same integrated circuit.

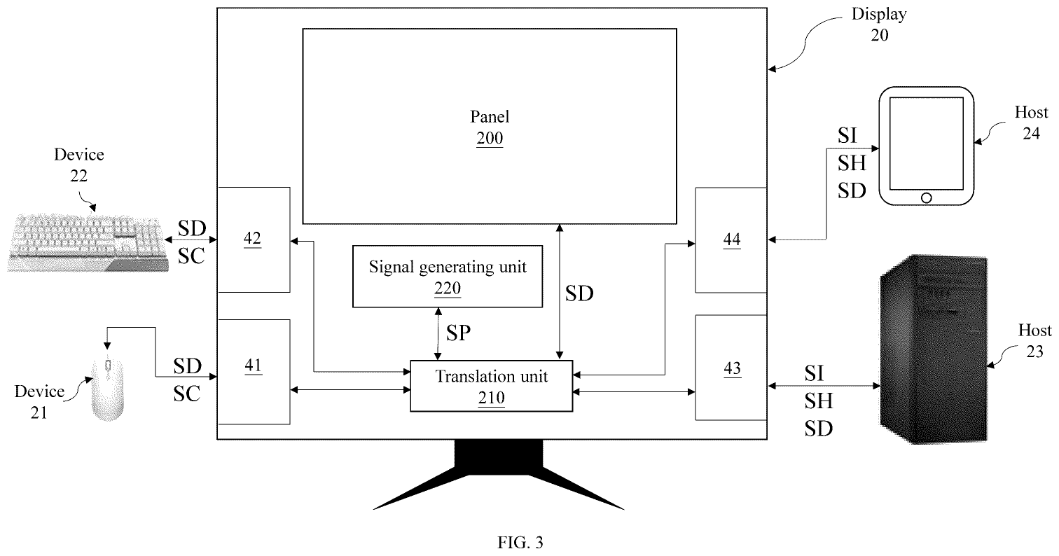

FIG. 3 is a schematic diagram illustrating a display 20 that connects the devices 21, 22 and the hosts 23, 24 according to some embodiments of the present disclosure. In some embodiments, the display 20 also has the function of a translator. In addition to displaying the image signal transmitted from the hosts 23 and 24, the display 20 is further configured to translate the devices 21 and 22 to the hosts 23 and 24.

The display 20 includes a panel 200, a translation unit 210, a signal generating unit 220, an interface 41, an interface 42, an interface 43 and an interface 44. The display 20 is connected to the device 21, the device 22, the host 23 and the host 24 through the interfaces 41 to 44, respectively.

Similar to the embodiment of FIG. 1, the display 20 is configured to switch the hosts 23 and 24, and keep the host 23 or the host 24 in the “handshake completion” state when the host 23 or the host 24 is in the idle state.

More specifically, the devices 21 and 22 are the same as the devices 11 and 12, the hosts 23 and 24 are the same as the hosts 14 and 15, the translation unit 210 is the same as the translation unit 110, and the signal generating unit 220 is the same as the signal generating unit 120; therefore, the detailed operations thereof are omitted herein for the sake of brevity. In some embodiments, the display 20 includes all the functions of the translator 10.

In some embodiments, the display 20 includes a scaler IC, a translation unit 210 and a signal generating unit 220 disposed on the scaler IC.

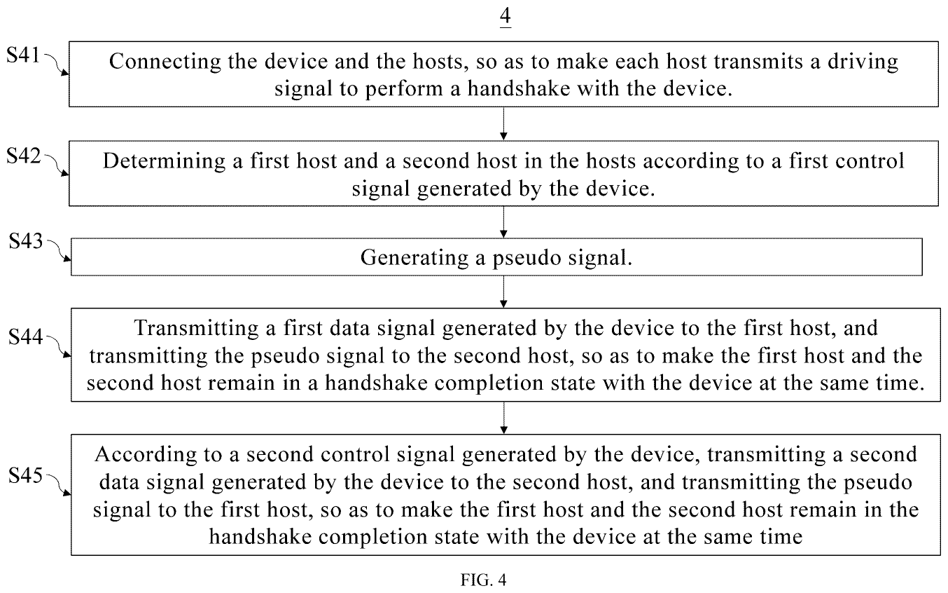

FIG. 4 is a flow chart of a translation method 4 according to other embodiments of the present disclosure. The translation method 4 is configured to translate a device and multiple hosts, such as the devices 11 to 13, hosts 14 to 15, devices 21 to 22 and hosts 23 to 24 shown in the embodiments of FIG. 1 and FIG. 3. In some embodiments, the translation method 4 is implemented using the translator 10. In some embodiments, the translation method 4 is implemented using the display 20. However, the present disclosure is not limited thereto, and the foregoing functions and operations of the translator 10 and the display 20 all fall within the scope of the translation method 4.

The translation method 4 includes steps S41, S42, S43, S44 and S45. For ease of understanding, the translation method 4 is explained by referencing to the reference numerals shown in FIG. 1.

In the step S41, the devices 11, 12, 13 and the hosts 14, 15 are connected such that each of the hosts 14 and 15 transmits a driving signal SI for performing a handshake with the devices 11, 12, and 13. In the step S42, one of the hosts 14 and 15 is determined to be a first host (in this case, the host 14) and the other to be a second host (in this case, the host 15) according a first control signal (corresponding to the control signal SC) generated by one of the devices 11 and 12. In the step S43, a pseudo signal SP is generated. In the step S44, a first data signal (corresponding to the data signal SD) generated by one of the devices 11 and 12 is transmitted to the first host, and the pseudo signal SP is transmitted to the second host, so that both of the first host and the second host remain in the handshake completion state with the devices 11 and 12. In the step S45, a second data signal (corresponding to the data signal SD) generated by one of the devices 11 and 12 is transmitted to the second host according to a second control signal (corresponding to the control signal SC) generated by one of the devices 11 and 12, and the pseudo signal SP is transmitted to the first host, so that both of the first host and the second host remain in the handshake completion state with the devices 11, 12, and 13.

In some embodiments, the translation method 4 further includes the step of turning on or turning off a function of supporting the communication protocols according to a third control signal (corresponding to the control signal SC) generated by one of the devices 11 and 12. In some embodiments, the translation method 4 further includes the step of performing the OSD to control the display (device 13) according to a fourth control signal (corresponding to the control signal SC) generated by one of the devices 11 and 12.

In some embodiments, the translation method 4 further includes the step of transmitting a first image signal (corresponding to the data signal SD) to the display, in which the first image signal is generated by the first host according to the first data signal; transmitting a third data signal (corresponding to the data signal SD) generated by one of the devices 11 and 12 to the first host, and transmitting the pseudo signal SP to the second host; after transmitting the third data signal to the first host, transmitting, according to the third data signal, a fourth data signal (corresponding to the data signal SD) generated by one of the devices 11 and 12 to the second host and transmitting pseudo signal SP to the first host; and transmitting a second image signal (corresponding to the data signal SD) to the display, in which that the second host is generates according to the fourth data signal.

The foregoing outlines features of several embodiments so that those skilled in the art may better understand various aspects of the present disclosure. Those skilled in the art should appreciate that they may readily use the present disclosure as a basis for designing or modifying other operations and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A translation method, configured to translate a device to a plurality of hosts, comprising:
determining a first host and a second host in the plurality of hosts according to a first control signal generated by the device;
generating a pseudo signal; and
transmitting a first data signal generated by the device to the first host, and transmitting the pseudo signal to the second host, so as to make the first host and the second host remain in a handshake completion state with the device at the same time.

2. The translation method of claim 1, further comprising:
connecting the device and the plurality of hosts, so as to make each host transmits a driving signal to perform a handshake with the device.

3. The translation method of claim 1, wherein the pseudo signal is configured to keep the second host from performing another operation while remaining in the handshake completion state.

4. The translation method of claim 1, further comprising:
according to a second control signal generated by the device, transmitting a second data signal generated by the device to the second host, and transmitting the pseudo signal to the first host, so as to make the first host and the second host remain in the handshake completion state with the device at the same time.

5. The translation method of claim 4, wherein the pseudo signal is configured to keep the first host from performing another operation while remaining in the handshake completion state.

6. The translation method of claim 1, further comprising:
turning on or turning off a support function of a communication protocol according to a third control signal generated by the device.

7. The translation method of claim 1, further comprising:
according to a fourth control signal generated by the device, performing an on-screen display (OSD) to control a display.

8. The translation method of claim 1, further comprising:
transmitting a first image signal generated by the first host according to the first data signal to a display;
transmitting a third data signal generated by the device to the first host, and transmitting the pseudo signal to the second host;
according to the third data signal, after transmitting the third data signal to the first host, transmitting a fourth data signal generated by the device to the second host, and transmitting the pseudo signal to the first host; and
transmitting a second image signal generated by the second according to the fourth data signal to the display.

9. A translator, configured to translate a device to a plurality of hosts, comprising:
a translation unit, configured to receive a first control signal generated by the device, and determine a first host and a second host of the plurality of hosts according to the first control signal, wherein the first host is active, and the second host is idle; and
a signal generating unit, configured to generate a pseudo signal,
wherein the translation unit is further configured to transmit a first data signal generated by the device to the first host and transmit the pseudo signal to the second host, so as to make the first host and the second host remain in a handshake completion state with the device at the same time.

10. The translator of claim 9, wherein the translation unit is further configured to receive a second control signal generated by the device, and switch the second host to active and switch the first host to idle according to the second control signal, wherein the translation unit is further configured to transmit a second data signal generated by the device to the second host and transmit the pseudo signal to the first host, so as to make the first host and the second host remain in the handshake completion state with the device at the same time.

11. The translator of claim 9, wherein the pseudo signal configured to keep the second host from performing another operation while remaining in the handshake completion state.

12. The translator of claim 9, wherein the translation unit is further configured to turn on or turn off a support function of a high-bandwidth digital content protection (HDCP) of the translator according to a third control signal generated by the device.

13. The translator of claim 9, wherein the translation unit is further configured to identify a third data signal generated by the device, to switch the second host to active and switch the first host to idle, and switch a first image signal displayed by a display to a second image signal,
wherein the first image signal is generated by the first host according to the third data signal, and the second image signal is generated by the second host according to a fourth data signal generated by the device.

14. A display, configured to translate a device to a plurality of hosts, comprising:
a signal generating unit, configured to generate a pseudo signal,
a translation unit, configured to:
receive a first control signal generated by the device, and determine a first host and a second host of the plurality of hosts according to the first control signal,
transmit a first data signal generated by the device to the first host, and transmit the pseudo signal to the second host, so as to make the first host and the second host remain in a handshake completion state with the device at the same time and, and
receive a first image signal generated by the first host according to the first data signal; and
a panel, configured to display the first image signal.

15. The display of claim 14, wherein the translation unit is further configured to:
receive a second control signal generated by the device, transmit a second data signal generated by the device to the second host according to the second control signal, and transmit the pseudo signal to the first host, so as to make the first host and the second host remain in the handshake completion state with the device at the same time, and
receive a second image signal generated by the second host according to the second data signal,
wherein the panel is further configured to display the second image signal.

16. The display of claim 14, wherein the pseudo signal is configured to keep the second host from performing another operation while remaining in the handshake completion state.

17. The display of claim 14, wherein the device is a mouse, when the mouse moves to a boundary of a display range of the panel, the mouse correspondingly generate a third data signal to the translation unit, wherein the translation unit is further configured to:
transmit the third data signal to the first host and transmit the pseudo signal to the second host,
receive a third image signal generated by the first host according to the third data signal,
transmit a fourth data signal generated by the device to the second host according to the third data signal, and transmit the pseudo signal to the first host, wherein the fourth signal is generated after the third signal, and
receive a fourth image signal generated by the second host according to the fourth data signal.

18. The display of claim 17, wherein the panel is further configured to switch from displaying the third image signal to displaying the fourth image signal.

19. The display of claim 14, wherein the translation unit is further configured to turn on or turn off a support function of a HDCP according to a third control signal generated by the device.

20. The display of claim 14, wherein the translation unit is further configured to perform an OSD to control the panel according to a fourth control signal generated by the device.
